(19) United States
(12) Patent Application Publication
(10) Pub. No.: US 2005/0265883 A1
(43) Pub. Date: Dec. 1, 2005

(54) Dust ccre and process for producing the same

(76) Inventors: Kei Ishii, Chiba (JP); Tamio Takada, Chiba (JP); Isao Makino, Aichi (JP); Masaki Shimizu, Aichi (JP)

Correspondence Address: BIRCH STEWART KOLASCH & BIRCH, PO BOX 747, FALLS CHURCH, VA, 22040-0747, US

(21) Appl. No.: 10/520,119

(22) PCT Filed: Jul. 9, 2003
(86) PCT No.: PCT/JP03/08730

§ 371 Date: Jan. 3, 2005

(30) Foreign Application Priority Data
Aug. 7, 2002 (JP) 2002-229712
Aug. 7, 2002 (JP) 2002-229713

(51) Int. Cl. H01F 1/28

(52) U.S. Cl. 419/10; 75/230

(57) ABSTRACT

A powdered core made by compacting of a mixture of iron powder and resin powder of insulating binder, wherein the iron powder is composed of atomized iron powder and reduced iron powder, and the resin powder is any one of thermosetting polyimide powder, a mixture of both thermosetting polyimide powder and polytetrafluoroethylene powder, thermoplastic polyimide powder, and a mixture of both thermoplastic polyimide powder and polytetrafluoroethylene powder, which is followed by heat treatment, thereby obtaining a powdered core having high magnetic flux density, low iron loss, and having excellent machinability in shaping, cutting or drilling without forming any,defects such as chipping or cracks.

### TECHNICAL FIELD

This invention relates to a powdered core and a method for producing the same.

### BACKGROUND ART

Powdered cores are made of magnetic particles of highly pure iron powder and they are used as the iron cores for electric motors, transformers, and so forth. The term “powdered core” herein referred to is also known as “dust core”, “powdered magnetic core”, “powdered-iron core” and “ferrite core”. It is known that the powdered cores of this kind have comparatively high magnetic flux density and low iron loss.

These powdered cores are made by compacting of iron powder containing a binder resin of insulating material and the obtained green compacts are then subjected to heat treatment. The products are sometimes further subjected to drilling or thread cutting process.

The magnetic flux density of powdered core depends upon its physical density, so that atomized iron powder is generally used as an iron powder material because it is possible to produce high-density products. In order to reduce the iron loss of powdered core product, the surfaces of the iron powder particles are coated with a phosphate compound. The iron powder of this kind is available on the market such as “Somaloy 500“, trade name of Höganäs AB.

As the insulating resins used as binders, several kinds of resins are proposed such as thermosetting phenol resin, thermoplastic polyamide, epoxy resin, polyimide and polyphenylene sulfide (PPS).

Because the powdered cores of this kind are used under the condition of relatively high frequency, there is growing tendency to demand the powdered cores which generate higher magnetic flux density and have lower iron loss. In addition, conventional powdered cores have a problem to be solved in that cracking or chipping is liable to occur during the machining or drilling process.

As a result of scrutinizing the above-mentioned circumstances, the inventors have accomplished the present invention by finding the fact that the problems can be solved by selecting the kinds and addition quantities of iron powders and binder resins.

### DISCLOSURE OF INVENTION

The present invention will be described in more detail.

A first aspect of the present invention relates to a powdered core which is made by compacting of a mixture of both iron powder and resin powder, wherein the iron powder comprises atomized iron powder and reduced iron powder and the resin powder comprises a member selected from the group consisting of thermosetting polyimide (hereinafter referred to as “thermosetting PI”) powder, a mixture of both thermosetting PI powder and polytetrafluoroethylene powder, thermoplastic polyimide (hereinafter referred to as “thermoplastic PI”) powder, and a mixture of both thermoplastic PI powder and polytetrafluoroethylene powder.

A second aspect of the present invention relates to the powdered core which is made by compacting of the mixture of iron powder and resin powder, wherein the iron powder contains 5 to 70% of reduced iron powder and the resin powder is thermosetting polyimide powder of 0.01 to 0.15% relative to the total amount of the powder mixture. Unless otherwise indicated, the value in “%” or “percent” herein used means “% by mass” or “percent by mass”, respectively.

A third aspect of the present invention relates to the powdered core which is made by compacting of the mixture of iron powder and resin powder, wherein the iron powder contains 5 to 70% of reduced iron powder and the resin powder comprises both thermosetting polyimide powder and polytetrafluoroethylene powder of 0.01 to 0.15% relative to the total amount of the powder mixture.

A fourth aspect of the present invention relates to the powdered core which is made by compacting of the mixture of iron powder and resin powder, wherein the iron powder contains 5 to 50% of reduced iron powder and the resin powder comprises thermoplastic polyimide powder of 0.3% or less relative to the total amount of the powder mixture.

A fifth aspect of the present invention relates to the powdered core which is made by compacting of the mixture of iron powder and resin powder, wherein the iron powder contains 5 to 50% of reduced iron powder and the resin powder comprises both thermoplastic polyimide powder and polytetrafluoroethylene powder of 0.3% or less in sum relative to the amount of the powder mixture.

A sixth aspect of the present invention relates to a method for producing a powdered core, which method comprises the steps of mixing atomized iron powder and reduced iron powder together in a ratio (as the former:the latter) in the range of 95:5 to 30:70%, the surfaces of atomized iron powder particles being coated with phosphate compound; adding a resin powder of a member selected from the group consisting of thermosetting polyimide, a combination of both thermosetting polyimide and polytetrafluoroethylene, thermoplastic polyimide, and a combination of both thermoplastic polyimide and polytetrafluoroethylene to the iron powder mixture, and then subjecting the obtained mixture to compacting in a compacting die, the wall of which is coated with a lubricant, to obtain a green compact, and subsequently subjecting the green compact to heat treatment, and, when occasion demands, further subjecting the obtained heat-treated product to the machining process of cutting or grinding.

### BRIEF DESCRIPTION OF DRAWINGS

FIG. 1 is a graph showing the relationship between the contents of a resin (thermoplastic PI or thermosetting PI) and densities in the powdered cores made of atomized iron powder.

FIG. 2 is a graph showing the relationship between the contents of a resin (thermoplastic PI or thermosetting PI) and radial crushing strengths of the powdered cores made of atomized iron powder.

FIG. 3 is a graph showing the relationship between the contents of a resin (thermoplastic PI or thermosetting PI) and magnetic flux densities of the powdered cores made of atomized iron powder.

FIG. 4 is a graph showing the relationship between the contents of a resin (thermoplastic PI or thermosetting PI) and iron losses of the powdered cores made of atomized iron powder.

FIG. 5 is a graph showing the relationship between the contents of reduced iron powder and densities of the powdered cores made of atomized iron powder singly or both reduced iron powder and atomized iron powder.

FIG. 6 is a graph showing the relationship between the contents of reduced iron powder and radial crushing strengths of the powdered cores made of atomized iron powder singly or both reduced iron powder and atomized iron powder.

FIG. 7 is a graph showing the relationship between the contents of reduced iron powder and magnetic flux densities of the powdered cores made of atomized iron powder singly or both reduced iron powder and atomized iron powder.

FIG. 8 is a graph showing the relationship between the contents of reduced iron powder and iron losses of the powdered cores made of atomized iron powder singly or both reduced iron powder and atomized iron powder.

FIG. 9 is a graph showing the relationship between the contents of reduced iron powder and densities of the powdered cores made by changing the contents of reduced iron powder and the contents of thermosetting PI.

FIG. 10 is a graph showing the relationship between the contents of reduced iron powder and magnetic flux densities of the powdered cores made by changing the contents of reduced iron powder and the contents of thermosetting PI.

FIG. 11 is a graph showing the relationship between densities and magnetic flux densities of the powdered cores, which is induced from the results shown in FIGS. 9 and 10.

FIG. 12 is a graph showing the relationship between the contents of reduced iron powder and iron losses of the powdered cores made of both atomized iron powder and reduced iron powder by changing the contents of thermosetting PI.

FIG. 13 is a graph showing the relationship between the contents of reduced iron powder and densities of the powdered cores made of both atomized iron powder and reduced iron powder, using thermosetting PI singly or both thermosetting PI and PTFE.

FIG. 14 is a graph showing the relationship between the contents of reduced iron powder and magnetic flux densities of the powdered cores made of both atomized iron powder and reduced iron powder, using thermosetting PI singly or both thermosetting PI and PTFE.

FIG. 15 is a graph showing the relationship between the contents of reduced iron powder and iron losses of the powdered cores made of both atomized iron powder and reduced iron powder, using thermosetting PI singly or both thermosetting PI and PTFE.

FIG. 16 is a graph showing the relationship between the contents of reduced iron powder and densities of the powdered cores, using a resin of thermoplastic PI.

FIG. 17 is a graph showing the relationship between the contents of reduced iron powder and magnetic flux densities of the powdered cores, using a resin of thermoplastic PI.

FIG. 18 is a graph showing the relationship between the contents of reduced iron powder and iron losses of the powdered cores, using a resin of thermoplastic PI.

FIG. 19 is a graph showing the relationship between the contents of reduced iron powder and radial crushing strengths of the powdered cores, using a resin of thermoplastic PI.

### BEST MODE FOR CARRYING OUT THE INVENTION

The present invention will be described in more detail with reference to examples and modes for carrying out the invention.

The powders used in experiments, the method for producing powdered cores and measurement methods for characteristics are described in the following.

1. Iron Powder

(1) Atomized iron powder of 200 μm or smaller in particle diameter that is coated with very thin insulating layer of a phosphate compound, which is produced by Höganäs AB (trade name: “Somaloy 500”)

(2) Reduced iron powder of 200 μm or smaller in particle diameter that is coated with very thin insulating layer of a phosphate compound, which is produced by Höeganäs AB (trade name: “Permite 75”)

2. Resin Powders

(1) Thermoplastic PI powder: 20 μm in average particle diameter

(2) Thermosetting PI powder: 20 μm in average particle diameter

(3) PTFE powder: 5 μm in average particle diameter

3. Compacting

A dispersion of 5% in ethyl alcohol of lubricant powder (zinc stearate) was applied to the wall surfaces of a compacting die at 100° C. After drying the coated surface, the die was fed with heated mixture of iron powder and resin powder and compacting was carried out at a temperature of 100° C. and a pressure of 1560 MPa.

4. Heat Treatment of Green Compacts

(1) Green compacts containing thermoplastic PI were heated in nitrogen gas atmosphere at 400° C. for 1 hour.

(2) Green compacts containing thermosetting PI were heated in the air at 200° C. for 2 hours.

5. Test Pieces

Heat-treated articles were subjected to boring and end face scraping to form cylindrical test pieces of 10 mm in inner diameter, 23 mm in outer diameter and 10 mm in length.

6. Characteristics

(1) The magnetic flux density (T) was measured at 8000 A/m in magnetic field strength.

(2) The iron loss (kW/m³) was measured at 0.25 T (Tesla) in applied magnetic flux density and 5 kHz in frequency.

(3) The radial crushing strength (MPa) was measured according to JIS Z 2507-1979 “Sintered metal bearing—Determination of radial crushing strength”, (corresponding to ISO 2739 “Sintered Metal Bushes—Determination of Radial Crushing Strength”).

(4) The density (Mg/m³) was measured according to JIS Z 2505-1979 “Determination of density of sintered metal material”, (corresponding to ISO 2738 “Permeable Sintered Metal Materials—Determination of Density, Oil Content and Open Porosity”).

1) Thermosetting PI and Thermoplastic PI

Powdered cores were produced by using iron powders of both atomized iron powder and reduced iron powder, and resin powders of thermosetting PI and thermoplastic PI, and comparison test were carried out. It was understood that the thermosetting PI is suitable when the preparation of powdered cores having iron loss of 3000 kW/m³ or less are intended. Meanwhile, thermoplastic PI can be used when the iron loss is acceptable up to about 3500 kW/m³.

In the following, the uses of these resins are described.

2) Thermosetting PI

Explanation will be made with reference to graphs showing their characteristics obtained by experiments.

1. Types and Contents of Resins

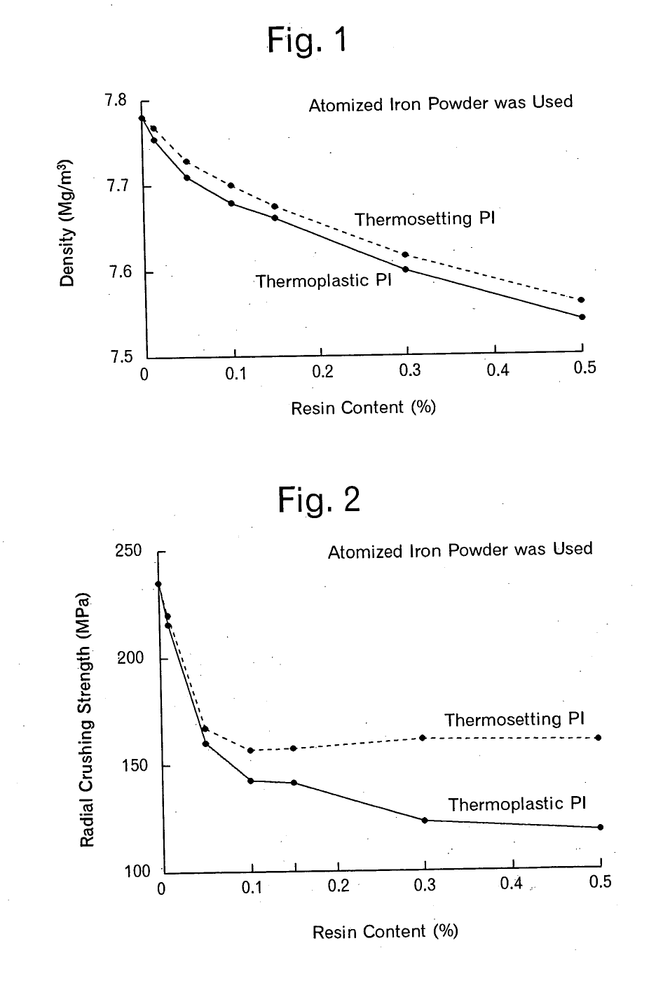

FIGS. 1 to 4 show several characteristics of powdered cores made by using atomized iron powder singly with various contents of thermoplastic PI or thermosetting PI.

FIG. 1 shows the densities of powdered cores, by which it is understood that the more the resin contents, the lower the densities. In the powdered cores containing thermosetting PI, the densities are generally higher than those containing thermoplastic PI.

FIG. 2 shows radial crushing strengths of powdered cores, in which the more the addition of resin, the lower the radial crushing strengths. In the case of powdered cores made by using thermoplastic PI, the radial crushing strength decreases with the increase of the resin contents. Meanwhile, when the thermosetting PI is used, the radial crushing strengths are on an almost constant level when the resin contents are more than 0.1%.

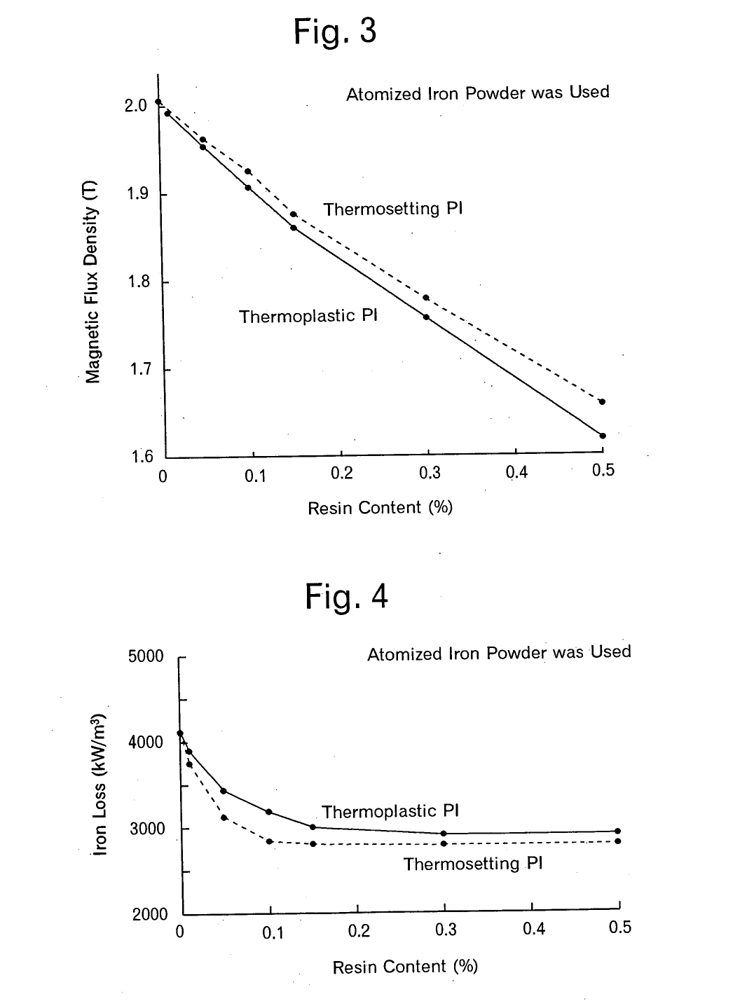

FIG. 3 shows magnetic flux densities. The values decrease with the increase of resin contents. In the case of the use of thermosetting PI, the tendency of lowering is lesser. The magnetic flux densities have correlation between the densities that are shown in FIG. 1.

FIG. 4 shows iron losses (core losses). The values largely decrease with the increase of resin contents. The degree of lowering in iron losses with the addition of resins is ceased when the resin contents exceed a certain level. The iron losses with the use of thermosetting PI are lower and the values are almost constant when the resin contents are 0.10% or more.

The forgoing results of experiments are summarized in the following passage.

(1) The powdered cores made by using thermosetting PI are superior to the others. Powdered cores made by adding thermosetting PI have higher densities, higher magnetic flux densities, lower iron losses and higher radial crushing strengths than these values in the powdered cores made by adding thermoplastic PI.

(2) In the powdered cores, the smaller the contents of thermosetting PI, the higher the densities, radial crushing strengths and magnetic flux densities.

(3) The iron loss decreases largely with the increase of the content of thermosetting PI up to the level of about 0.1%, however, the value does not decrease with the increase of the resin content of more than about 0.15%.

(4) Because the density, radial crushing strength and magnetic flux density decrease with the increase of thermosetting PI content, it can be known that the content of thermosetting PI is preferably low.

By the way, in the machine-finished surfaces of powdered cores, there are observed rough surfaces and sometimes small chipped off edges, regardless of the kinds or contents of used resins, so that the problems of this kind must be eliminated.

2. Characteristics of Powdered cores made by using a Mixture of Atomized Iron Powder and Reduced Iron Powder

The reason why the machinability of powdered cores made by using atomized iron powder is not good as mentioned above, is supposed that the particles of iron powder are liable to drop off or flake off in machining. It is owing to the shapes of atomized iron powder particles themselves having smooth surfaces and comparatively small specific surface areas.

In the experiment of machining powdered cores made by using reduced iron powder having relatively larger specific surface areas, the machined surfaces of powdered cores are satisfactorily smooth. However, the powdered cores made by using reduced iron powder hardly have high magnetic flux density, because it is difficult to form higher density products by using reduced iron powder owing to the fact that the reduced iron powder is relatively inferior in compressibility.

In view of the above fact, the effects on the magnetic flux density, iron loss and machinability in the use of the mixture of atomized iron powder and reduced iron powder, were examined.

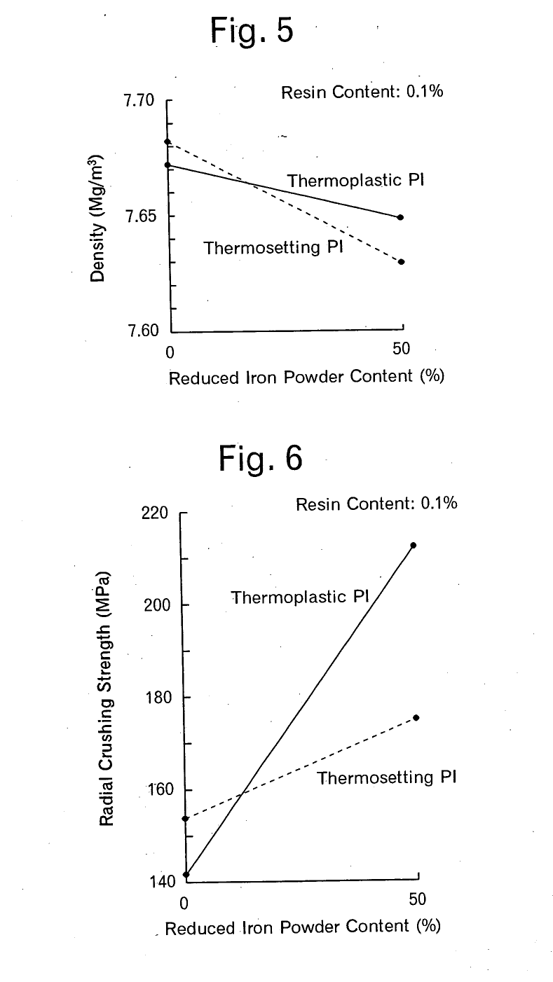

FIGS. 5 to 8 show the characteristics of powdered cores made by using only atomized powder, which correspond to the point of 0% in reduced iron powder, and 1:1 by mass mixture of atomized iron powder and reduced iron powder, with using a binding resin of thermosetting PI or thermoplastic PI at a content of 0.1% relative to the whole quantity of the powder mixture.

FIG. 5 shows densities, in which as compared with the powdered cores made of only atomized iron powder (reduced iron powder is 0%), the powdered cores containing 50% reduced iron powder are low in densities. In the case of powdered core containing reduced iron powder and thermosetting PI, the lowering of the density of powdered core is larger.

FIG. 6 shows radial crushing strengths. The powdered cores containing reduced iron powder have higher radial crushing strengths. In the cases of powdered core containing reduced iron powder and thermosetting PI, the increase in the radial crushing strength is smaller.

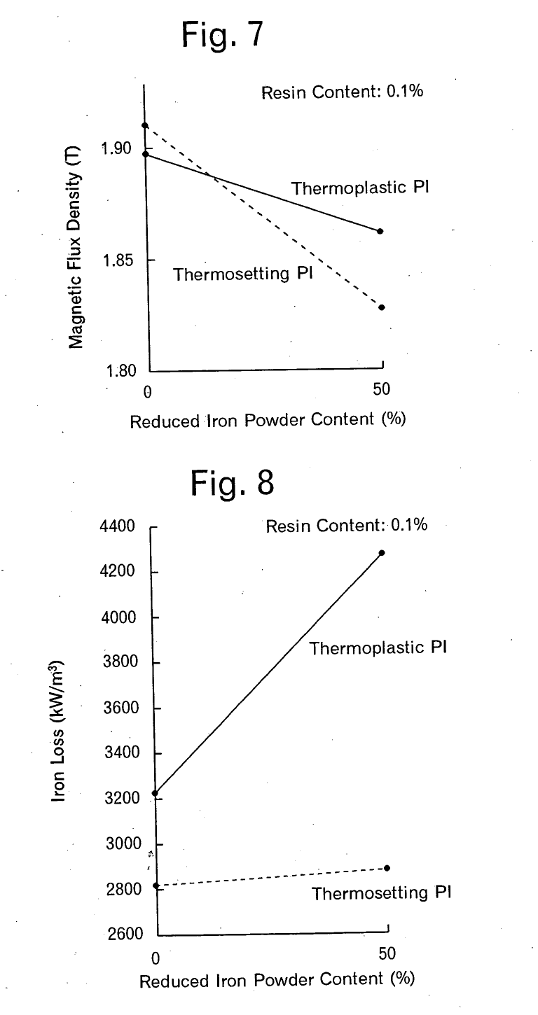

FIG. 7 shows magnetic flux densities and the values are low when the powdered cores contain reduced iron powder. In addition, the powdered core containing reduced iron powder and thermosetting PI largely decreases in the magnetic flux density.

FIG. 8 shows iron losses and the values are higher when the powdered cores contain reduced iron powder. Although the iron loss of the powdered core containing the reduced iron powder and thermoplastic PI is extremely high, the iron loss of powdered core containing only atomized iron powder and thermosetting PI is low and that value hardly increases with the addition of reduced iron powder. In other words, the iron loss of a powdered core containing thermosetting PI does hardly increase, even if the thermosetting PI is used in combination with the additional reduced iron powder.

The powdered core containing reduced iron powder apparently excels in the machinability.

The results of the forgoing experiments, in which the reduced iron powder was added to the atomized iron powder, are summarized in the following.

(1) As compared with the powdered cores made of only atomized iron powder, the powdered cores containing the reduced iron powder are not good in the compressibility and low in the density, so that the magnetic flux density of the latter powdered core is inferior.

(2) The radial crushing strength of powdered core containing reduced iron powder is high.

(3) In the case that powdered cores contain reduced iron powder, the iron loss is lower when thermosetting PI is added as compared with the addition of thermoplastic PI.

(4) The machinability is markedly improved by the addition of reduced iron powder.

(5) In view of the above-described facts, the powdered cores containing reduced iron powder is low in both the density and the magnetic flux density as compared with those made of only atomized iron powder. In addition, the iron loss can be lowered by adding the thermosetting PI and, at the same time, the machinability is apparently improved. Therefore, the use of reduced iron powder is suitable for producing powdered cores in which machining is required.

3. Effect of Quantities of Atomized Iron Powder and Reduced Iron Powder, and Effect of Addition of Thermosetting PI

In view of the above results, the effect of quantities of atomized iron powder and reduced iron powder; and the effect of addition of thermosetting PI were tested more particularly in order to obtain suitable combinations of them.

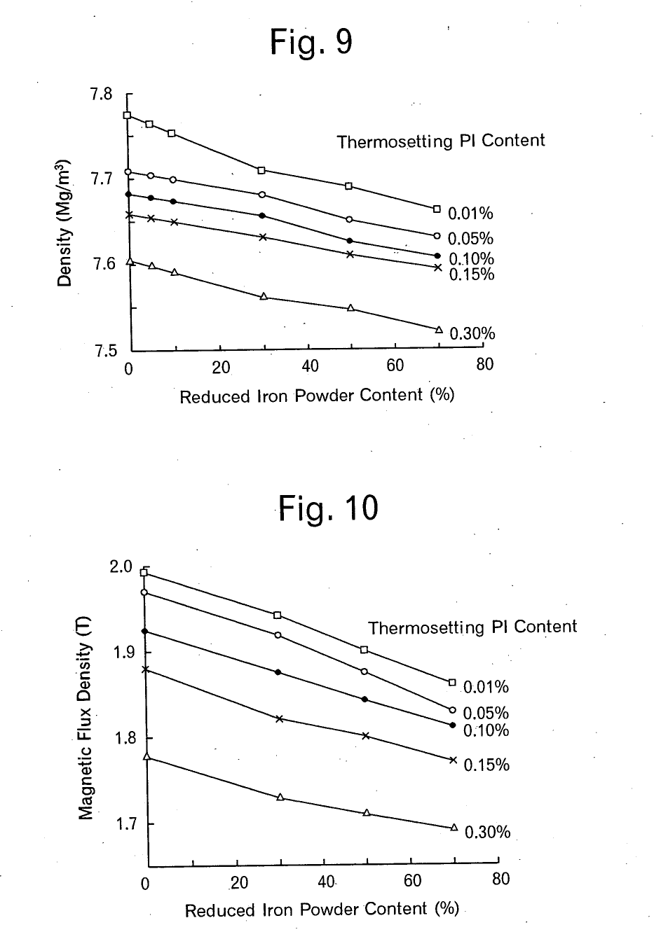

FIGS. 9 to 12 show the characteristics of powdered cores containing atomized iron powder, reduced iron powder, and thermosetting PI, in which contents of them were varied.

FIG. 9 shows densities of powdered cores. It is understood that when the content of reduced iron powder or the content of thermosetting PI increases, the densities are lowered.

FIG. 10 shows magnetic flux densities of powdered cores. In the like manner as the densities shown in FIG. 9, the magnetic flux densities become low with the increase of the content of reduced iron powder or thermosetting PI.

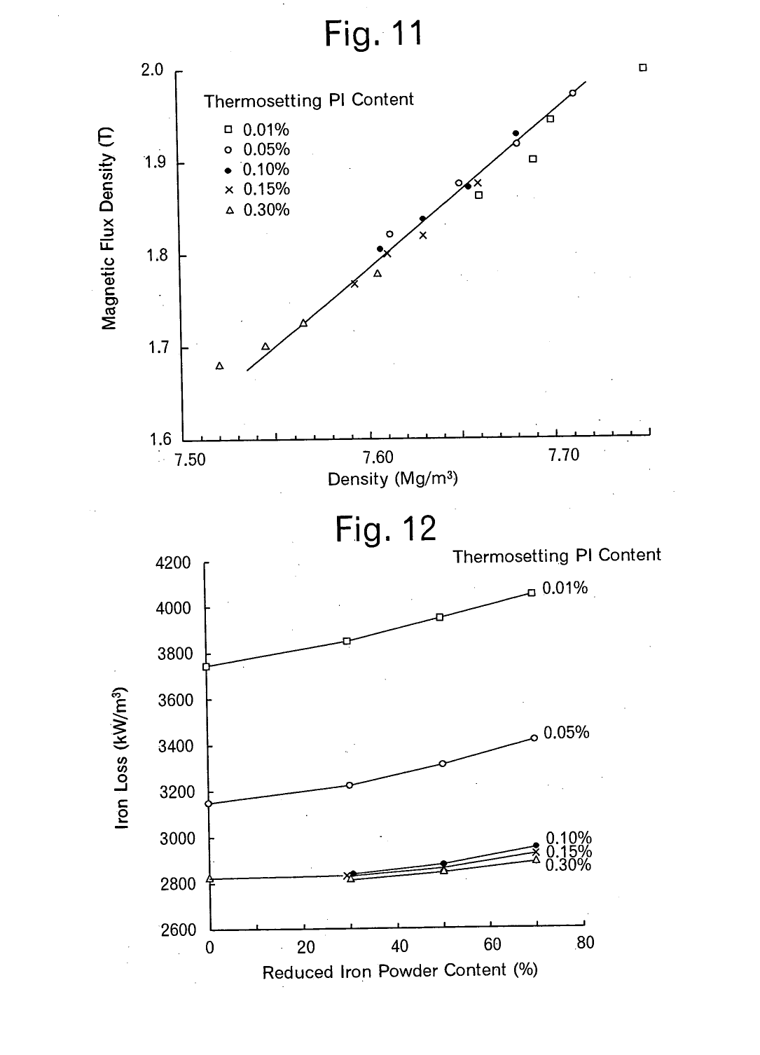

The relationship between the densities and the magnetic flux densities that are induced from the results in FIGS. 9 and 10, is shown in FIG. 11. There is a correlation between densities and magnetic flux densities regardless of the contents of thermosetting PI and the contents of reduced iron powder. The correlation indicated in this graph is represented by the following formula:
B=1.7d−11.14
wherein (B) denotes magnetic flux density and (d), density.

FIG. 12 shows iron losses of powdered cores. The iron losses increase with the increase of reduced iron powder content. Although the iron losses are almost on a similar level when the contents of thermosetting PI are in the range of 0.10% to 0.30%, the iron loss values increase when the content of thermosetting PI is made 0.05% or less.

With regard to the worked surfaces after machining, the effect is observed with the addition 5% of reduced iron powder, regardless of contents of thermosetting PI. It is possible to produce more preferable machined surfaces with the increase of the content of reduced iron powder.

The results of the forgoing experiments are summarized in the following.

(1) A powdered core made by using 50% or less of reduced iron powder and 0.15% or less of thermosetting PI has a magnetic flux density of 1.8 T or more. In view of the known fact that the powdered core made of atomized iron powder containing 0.3% of polyphenylene sulfide has a magnetic flux density of 1.7 T, the value in magnetic flux density of 1.8 T is on a rather higher level.

(2) In the case that a magnetic flux density of more than 1.75 T is intended, which is higher than that of the above reference product, it is possible to attain the object by the use of powder material containing 0.15% or less of thermosetting PI and 70% or less of reduced iron powder.

(3) In the case that a product of 3000 kW/m³ or less in iron loss is intended, it is possible to achieve the object by using a powder material containing 0.10% or more of thermosetting PI and 70% or less of reduced iron powder.

(4) If there is no limitation in the value of iron loss, it is preferable to use a powder material of lower resin content because the magnetic flux density of powdered core can be made high.

(5) The conditions of machined surfaces such as roughness and other defects caused in machining of powdered cores can be improved by the use of powder material containing reduced iron powder. It is necessary that the content of reduced iron powder is 5% or more in order to improve the machined surfaces. The more the content of reduced iron powder, the better the surface conditions.

In view of the above-mentioned facts, the preferable content of reduced iron powder is in the range of 5 to 50% and thermosetting PI is in the range of 0.10 to 0.15% in order to obtain powdered cores having improved machinability, 1.8 T or more of magnetic flux density and 3000 kW/m³ or less of iron loss.

In the case that powdered cores have magnetic flux density of 1.75 T or higher and comparatively high iron loss is acceptable, it is possible to achieve the object by using powder material containing reduced iron powder of 5 to 70% and thermosetting PI of 0.15% or less.

When higher magnetic flux density is required but relatively high iron loss is accepted, the content of thermosetting PI can be the lowest value of 0.01%, at which the lowering in iron loss is observed. In this case, the powdered core desirably has a higher magnetic flux density and lower iron loss, so that it is preferable that the reduced iron powder content does not exceed 50%.

4. Improvement in Compressibility of Powder Material by Addition of PTFE

As described above, the machinability of the powdered core can be improved by the addition of reduced iron powder, however, the compressibility of powder material becomes worse as compared with the powder material composed of sole atomized iron powder. Accordingly, it is necessary to increase the compressive load applied to the powder material in order to produce powdered cores having a higher magnetic flux density.

The effect of lubricant powder was examined in order to increase easily the density (i.e., the improvement in compressibility) and, as a result, to increase the magnetic flux density. The lubricant powder used herein was PTFE (polytetrafluoroethylene).

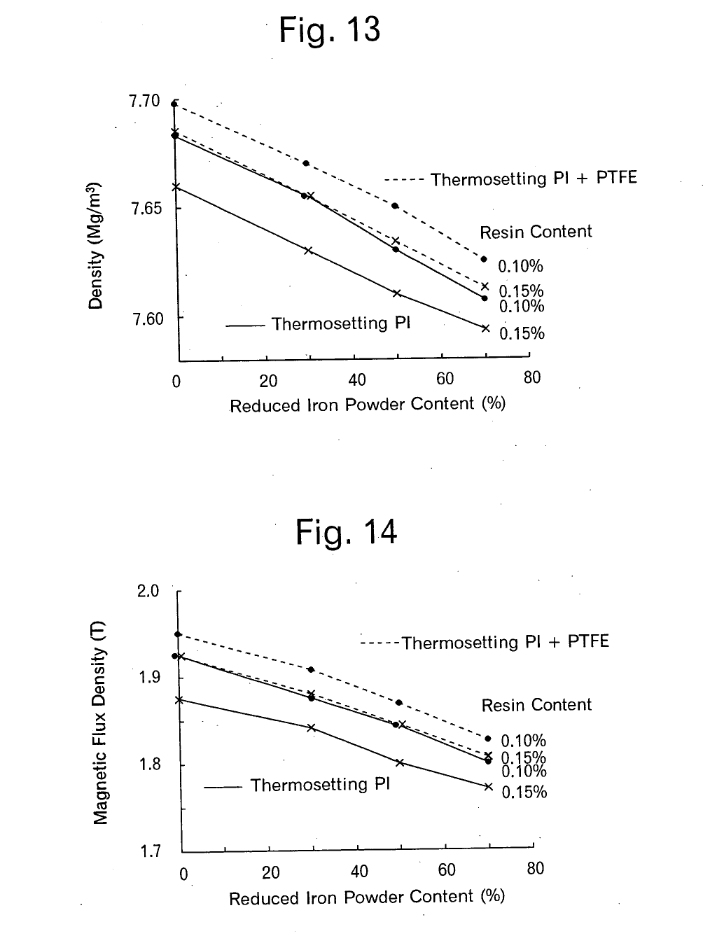

FIGS. 13 to 15 show characteristics of powdered cores made by using only thermosetting PI and those made by using a mixture of thermosetting PI and PTFE in the ratio of 1:1 by mass. In the experiment, the ratios of atomized iron powder and reduced iron powder were varied with the resin contents of 0.10% and 0.15% relative to the total amount of powder materials. These powdered cores were produced in the like manner as in the foregoing experiments. The heat treatments were carried out also in the like manner as in the foregoing experiments using thermosetting PI.

FIG. 13 shows densities, in which the densities of powdered cores made by using the mixture of thermosetting PI and PTFE are higher by 0.02 Mg/cm³ than the results of the powdered cores made by using only thermosetting PI.

FIG. 14 shows magnetic flux densities, in which the resultant values of powdered cores that were made by using the mixture of thermosetting PI and PTFE are increased as a result of the increase in densities. Even in the cases of powdered cores made of powder material containing reduced iron powder of 70% and the mixture of thermosetting PI and PTFE of 0.10%, the magnetic flux densities exceed the value of 1.8 T.

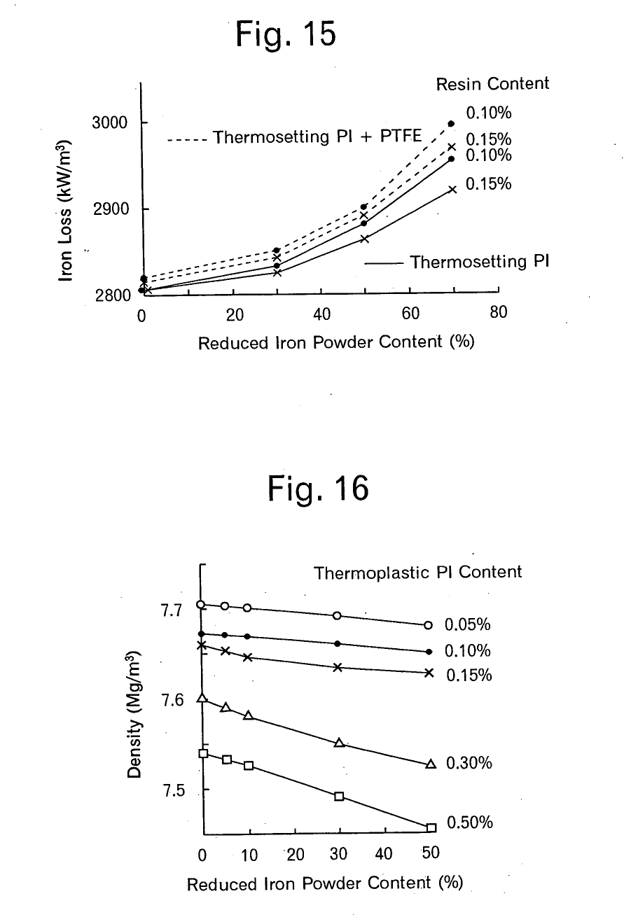

FIG. 15 shows iron losses. The iron losses of powdered cores made by using the mixture of thermosetting PI and PTFE are slightly higher than those made by using only thermosetting PI. Even in the powdered core made of the powder material containing reduced iron powder of 70% and the mixture of thermosetting PI and PTFE of 0.10%, the iron loss is lower than 3000 kW/m³.

The results in the forgoing experiments are summarized in the following.

(1) When a part of thermosetting PI is replaced by PTFE, the compressibility of the powder material can be improved, so that high density products can be obtained. Therefore, powdered cores having high magnetic flux densities can be produced. Accordingly, it is possible to increase the content of reduced iron powder in the iron powder mixture. It is indicated that, when the powder material contains PTFE, the frictional resistance among iron powder particles and that between the iron powder particles and the wall of compacting die are reduced in the powder compacting process.

(2) PTFE raises slightly the iron loss as compared with the use of thermosetting PI singly. However, when the content of PTFE is 0.10%, the iron loss of 3000 kW/m³ or less can be attained even when the content of reduced iron powder is 70%.

In view of these results, it is understood that a powdered core of high density and high magnetic flux density can be produced by using the powder material containing. 0.01% to 0.15% of thermosetting PI, or preferably by using the powder material, in which a part of thermosetting PI of 0.10 to 0.15% is replaced by PTFE. Even when the content of thermosetting PI is as much as 0.15% and the content of reduced iron powder is as much as 70%, the powdered cores having higher magnetic flux density and lower iron loss can be produced.

5. Method for Producing Powdered core Containing PTFE

As described above, if the powder material contains PTFE, it is possible to improve the compressibility of powder mixture, thereby facilitating the production of powdered cores having a high magnetic flux density.

In the above experiments, the ratio of thermosetting PI to PTFE was 1:1 by mass, however, any ratios such as 3:1 or 1:3 can be adopted in order to make the iron loss satisfactory in accordance with the content of reduced iron powder.

It is preferable that the content of PTFE is three-fourths (¾) or less relative to the whole content of resins because the PTFE makes the iron loss large as compared with the thermosetting PI.

When PTFE is added, the heat treatment of green compacts is carried out at temperatures of 150 to 250° C., preferably at 200° C., which is suitable for treating the material containing thermosetting PI. At higher temperatures at which the PTFE is softened or melted, the thermosetting PI is deteriorated to lose insulating property and the iron loss becomes large. For this reason, the heat treatment is carried out at temperatures in the range of 150° C. to 250° C.

As described above, the machined surfaces of powdered cores can be improved by using both the atomized iron powder and the reduced iron powder. If the used rein powder is thermosetting PI, obtained products excel in the magnetic flux density and iron loss. In addition, when the resin powder of thermosetting PI is partially replaced by PTFE, the compressibility of powder material is improved, and accordingly, powdered cores having higher magnetic flux density can be obtained.

When the thermosetting PI is used, powdered cores having excellent magnetic characteristics can be obtained by using the powder material, in which the resin content is 0.01% to 0.15%, preferably 0.10 to 0.15% and the ratio of atomized iron powder to reduced iron powder is in the range of 95:5 to 30:70.

When the used powder material contains both the thermosetting PI and the PTFE, the powder material is prepared such that the total content of resins is 0.01 to 0.15%, preferably 0.10 to 0.15% and the ratio of atomized iron powder to reduced iron powder is in the range of 95:5 to 30:70, in addition, the content of PTFE is preferably three-fourths or less to the whole quantity of resins, thereby obtaining powdered cores having excellent magnetic characteristics.

3) Thermoplastic PI

The experiments described below were carried out by taking the already known information as follows.

(1) The reason why the powdered core made of atomized iron powder has a problem in machinability, is considered that the iron particles are liable to drop off during machining because the particles of atomized iron powder have relatively small specific surface areas.

(2) The powdered cores that are made by adding reduced iron powder and processed similarly, have smooth machined surfaces. However, when the reduced iron powder is added, the magnetic flux density of the powdered core is low owing to the comparatively low compressibility.

(3) Although the powdered cores made by using PPS or thermoplastic PI as binding resins have high density and high magnetic flux density, those made by using the thermoplastic PI are better in the insulation of iron particles and lower in iron loss.

(4) The iron loss decreases with the increase of the content of binder resin. Meanwhile, if the content exceeds 0.3% relative to the total quantity, powdered cores of high density are hardly obtained, so that it is difficult to obtain products having high magnetic flux density.

On the basis of the above knowledge, concerning the combinations of mixtures of atomized iron powder and reduced iron powder together with binder resins, preferable conditions for the respective magnetic flux density, iron loss and machinability are examined according to the results of experiments.

In the following, descriptions are made with reference to graphs showing several characteristics.

FIGS. 16 to 19 show various kinds of characteristics on the powdered cores that are made of iron powder containing only atomized iron powder, or both the atomized iron powder and the reduced iron powder by changing their compounding ratios, and a resin of thermoplastic PI also by changing its contents.

FIG. 16 shows the densities of powdered cores. The Figure corresponds to the relationship that is shown in FIG. 9, except that the thermosetting PI in FIG. 9 is replaced by thermoplastic PI in FIG. 16. The densities also become lower with the increase of the contents of reduced iron powder or the contents of thermosetting PI.

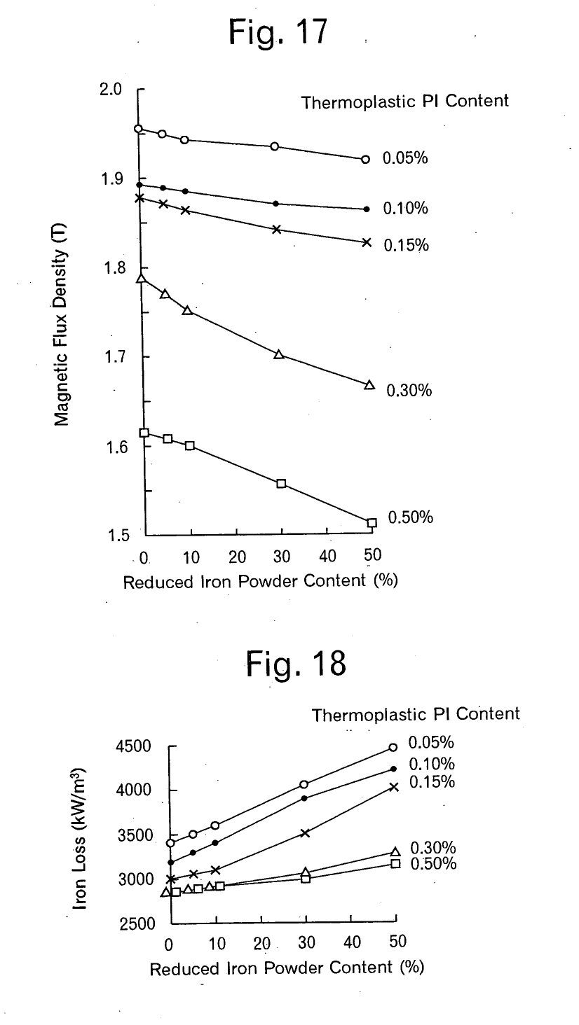

FIG. 17 shows magnetic flux densities of powdered cores. The magnetic flux densities become low with the increase of the contents of reduced iron powder and the increase of the contents of thermoplastic PI, in the like manner as the tendency in densities shown in FIG. 16. When summarizing the above data in the like manner as in FIG. 11, the densities correlate to the magnetic flux densities regardless of the contents of resin and the content of reduced iron powder. By observing the results in FIGS. 16 and 17 together, it is understood that when the density is 7.52 Mg/m³, the magnetic flux density is 1.60 T, when the density is 7.55 Mg/m³, the magnetic flux density is 1.7 T, and when the density is 7.60 Mg/m³, the magnetic flux density is 1.79 T. Furthermore, if the content of reduced iron powder is 50% or less, the magnetic flux density is more than 1.8 T when the content of resin is less than 0.15%, and the magnetic flux density is more than 1.65 T when the content of resin is less than 0.3%.

The powdered cores made of atomized iron powder containing 0.3% of PPS as being known in the prior art, have the magnetic flux density of about 1.7 T. In the case of the addition of thermoplastic PI as a resin material, the magnetic flux density is 1.79 T at the content of 0% of reduced iron powder (only atomized iron powder) and 0.3% of the resin, as shown in FIG. 17. So that, it is understood that the thermoplastic PI is superior to PPS.

In addition, in order to obtain powdered cores having higher magnetic flux density, it is preferable to reduce the content of thermoplastic PI and the content of reduced iron powder.

FIG. 18 shows iron losses of powdered cores, in which when the content of reduced iron powder is increased, the values in iron loss increases. On the other hand, it is desirable in that the more the resin contents, the lower the iron losses. Furthermore, even if the powder material contains more than 0.3% of the resin material, the iron loss decreases only by a little extent.

When the preparation of powdered cores having further lower iron losses are intended, the following ranges can be adopted in view of the results in FIG. 18. For example, in order to prepare powdered cores having the iron loss of less than about 3500 kW/m³, it is possible to select about 0.08% or more of thermoplastic PI in a powder material containing 10% of reduced iron powder; about 0.125% or more in a powder material containing 20% of reduced iron powder; and about 0.15% or more in a powder material containing 30% of reduced iron powder. In other words, the iron powder material is a mixture of atomized iron powder and 30% or less of reduced iron powder. The content of thermoplastic PI is desirably 0.3% or less relative to the total quantity of the powder mixture. The content of resin material can be determined in view of the linear correlation, which is plotted between the point of 10% of reduced iron powder with 0.3% of resin content and the point of 30% of reduced iron powder with 0.15% of resin content, wherein an actually adopted resin content may be an appropriate value which is larger than the above linear correlation.

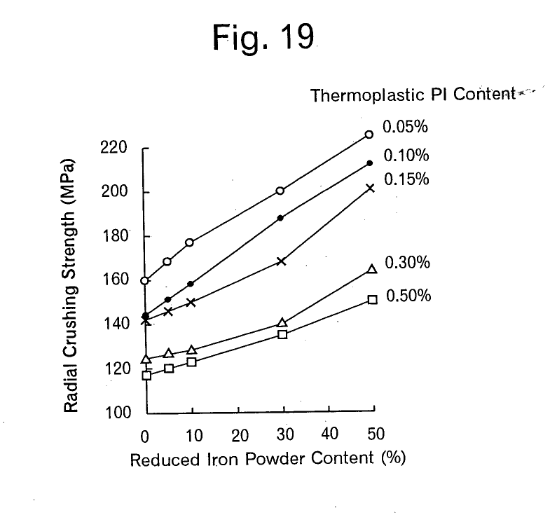

FIG. 19 shows radial crushing strengths of powdered cores. The value of radial crushing strength is improved with the increase in the content of reduced iron powder. On the other hand, the radial crushing strength is lowered when the content of thermoplastic PI is increases.

The machined surfaces of powdered cores after the processing with a lathe were then observed, as a result, it was confirmed that the machined surfaces were improved in test pieces in which 5% or more of reduced iron powder is contained, and with the increase in the content of reduced iron powder, the machined surfaces are smooth without defects such as scratches or chips.

The forgoing results are summarized in the following.

(1) When the atomized iron powder is mixed with the reduced iron powder, the obtained powdered cores have higher radial crushing strength and hardly have defects such as chipping off by machining. These advantages are observed by the addition of 5% or more of the reduced iron powder.

(2) When thermoplastic PI is used as the resin powder, the magnetic flux density is made high.

(3) When the content of reduced iron powder is 50% or less and the content of thermoplastic PI is 0.15% or less, the powdered cores having magnetic flux density of 1.8 T or higher can be obtained. When the resin content is 0.3% or less, powdered cores having 1.65 T or higher can be obtained. The magnetic flux density of the latter ones is lower by about 3% than the value of powdered cores made of the mixture of atomized iron powder and PPS, however, the powdered cores according to the present invention have distinctive feature in excellent machinability owing to the addition of reduced iron powder.

(4) In the case that the content of reduced iron powder is low and the content of thermoplastic PI is high, the value in iron loss is low. It does not produce any additional effect even when the content of resin is further increased above the level of 0.3%.

(5) In view of these facts, it is desirable that iron powder is composed of a mixture of atomized iron powder, reduced iron powder, and a resin powder of thermoplastic PI, in which the content of the reduced iron powder is 5 to 50% of the iron powder mixture, and the content of thermoplastic PI is 0.3% or less relative to the total quantity of powder material.

In the following, the powdered cores having lower iron losses and higher densities as compared with the above-mentioned ones are described.

It is known that high density powdered cores can be obtained by reducing the frictional resistance among iron particles in the compacting of powder mixture, so as to obtain powdered cores having higher magnetic flux density. The well-known lubricants are exemplified by mica, graphite, molybdenum disulfide and PTFE. In the present invention, PTFE was tested as a lubricant of resinous material.

In the experiments, powdered cores were prepared in the like manner as in the foregoing examples using powder mixtures of both atomized iron powder and reduced iron powder, and a resin material. The used powder mixture contained 10% and 30% of reduced iron powder and 0.15% of resin material. The resin material was thermoplastic PI in one group of powdered cores and, in another group, a half of the thermoplastic PI was replaced by PTFE.

After the formation of powdered cores, the characteristics of them containing PTFE were compared with those containing no PTFE, the results of which are shown in the following Table 1.

The powdered core made of the powder mixture containing PTFE has a higher magnetic flux density by 0.02 T owning to the fact that the density is higher by 0.01 Mg/m³ with improved compressibility of the powder mixture. In other words, it enables to choose a condition of low pressures in compacting. In addition, the iron loss is slightly low, which indicates that the PTFE has better insulating property as compared with the thermoplastic PI.

Although the ratio of thermoplastic PI to PTFE was 1:1 in the above experiments, in view of the effect to raise the density and to reduce the iron loss, the above ratio can be changed, for example, to 3:1 or 1:3.

TABLE 1

| | P T F E is | | P T F E is | |
|---|---|---|---|---|
| Use of P T F E | Contained | | not Contained | |
| Reduced Iron Powder Qty. (%) | 10 | 30 | 10 | 30 |
| Density (Mg/m³) | 7.66 | 7.64 | 7.65 | 7.63 |
| Magnetic Flux Density (T) | 1.89 | 1.85 | 1.87 | 1.83 |
| Iron Loss (kW/m³) | 3050 | 3350 | 3100 | 3500 |

### INDUSTRIAL APPLICABILITY

The powdered cores produced according to the present invention excel in machinability, so that the invention is suitable for producing the powdered cores of complicated shapes or of precise dimensions such as those which are finished by machining. Furthermore, because it is possible to provide powdered cores of high magnetic flux density and low iron loss, the present invention is suitable for producing electromagnetic products made by using downsized or power-saving powdered cores.

1. In a powdered core which is made by compacting of a mixture of iron powder and resin powder, said iron powder is composed of atomized iron powder and reduced iron powder, and said resin powder is at least one member selected from the group consisting of thermosetting polyimide powder, a mixture of both thermosetting polyimide powder and polytetrafluoroethylene powder, thermoplastic polyimide powder, and a mixture of both thermoplastic polyimide powder and polytetrafluoroethylene powder.

2. The powdered core as claimed in claim 1, which is made by compacting of said mixture of iron powder and resin powder, wherein said iron powder contains 5 to 70% by mass of reduced iron powder and said resin powder is thermosetting polyimide powder of 0.01 to 0.15% by mass relative to the total quantity of said powder mixture.

3. The powdered core as claimed in claim 1, which is made by compacting of said mixture of iron powder and resin powder, wherein said iron powder contains 5 to 70% by mass of reduced iron powder, and said resin powder comprises both thermosetting polyimide powder and polytetrafluoroethylene powder of 0.01 to 0.15% by mass relative to the total quantity of said powder mixture.

4. The powdered core as claimed in claim 1, which is made by compacting of said mixture of iron powder and resin powder, wherein said iron powder contains 5 to 50% by mass of reduced iron powder, and said resin powder is thermoplastic polyimide powder of 0.3% by mass or less relative to the total quantity of said powder mixture.

5. The powdered core as claimed in claim 1, which is made by compacting of said mixture of iron powder and resin powder, wherein said iron powder contains 5 to 50% by mass of reduced iron powder and said resin powder is a mixture of both thermoplastic polyimide powder and polytetrafluoroethylene powder of 0.3% by mass or less relative to the total quantity of said powder mixture.

6. A method for producing powdered cores, which comprises the steps of:
mixing together atomized iron powder and reduced iron powder in the ratio of 95:5 to 30:70% by mass as represented by (the former:the latter), particle surfaces of both of said iron powders being coated with a phosphate compound,
further adding to said iron powder mixture at least one member selected from the group consisting of thermosetting polyimide, a mixture of both thermosetting polyimide and polytetrafluoroethylene, thermoplastic polyimide, and a mixture of both thermoplastic polyimide and polytetrafluoroethylene,
then subjecting the thus formed mixture to compacting with a compacting die, the wall surfaces of which being coated by a lubricant, to obtain a green compact, and
subjecting said green compact to heat treatment, and if occasion demands, further subjecting the heat-treated product to machining of sizing, cutting, or grinding.
